(19) United States
(12) Patent Application Publication
(10) Pub. No.: US 2010/0088296 A1
(43) Pub. Date: Apr. 8, 2010

(54) SYSTEM AND METHOD FOR ORGANIZING DATA TO FACILITATE DATA DEDUPLICATION

(75) Inventors: Subramanian Periyagaram, Bangalore (IN); Rahul Khona, Santa Clara, CA (US); Dnyaneshwar Pawar, Bangalore (IN); Sandeep Yadav, Santa Clara, CA (US)

Correspondence Address: Perkins Coie LLP, P.O. Box 1208, Seattle, WA, 98111-1208, US

(73) Assignee: NetApp, Inc., Sunnyvale, CA (US)

(21) Appl. No.: 12/245,669

(22) Filed: Oct. 3, 2008

(51) Int. Cl. G06F 7/06; G06F 17/30

(52) U.S. Cl. 707/705; 707/E17.044; 707/E17.014

(57) ABSTRACT

A technique for organizing data to facilitate data deduplication includes dividing a block-based set of data into multiple “chunks”, where the chunk boundaries are independent of the block boundaries (due to the hashing algorithm). Metadata of the data set, such as block pointers for locating the data, are stored in a tree structure that includes multiple levels, each of which includes at least one node. The lowest level of the tree includes multiple nodes that each contain chunk metadata relating to the chunks of the data set. In each node of the lowest level of the buffer tree, the chunk metadata contained therein identifies at least one of the chunks. The chunks (user-level data) are stored in one or more system files that are separate from the buffer tree and not visible to the user.

### FIELD OF THE INVENTION

At least one embodiment of the present invention pertains to data storage systems, and more particularly, to a system and method for organizing data to facilitate data deduplication.

### BACKGROUND

A network storage controller is a processing system that is used to store and retrieve data on behalf of one or more hosts on a network. A storage server is a type of storage controller that operates on behalf of one or more clients on a network, to store and manage data in a set of mass storage devices, such as magnetic or optical storage-based disks or tapes. Some storage servers are designed to service file-level requests from hosts, as is commonly the case with file servers used in a network attached storage (NAS) environment. Other storage servers are designed to service block-level requests from hosts, as with storage servers used in a storage area network (SAN) environment. Still other storage servers are capable of servicing both file-level requests and block-level requests, as is the case with certain storage servers made by NetApp, Inc. of Sunnyvale, Calif.

In a large-scale storage system, such as an enterprise storage network, it is common for certain items of data, such as certain data blocks, to be stored in multiple places in the storage system, sometimes as an incidental result of normal operation of the system and other times due to intentional copying of data. For example, duplication of data blocks may occur when two or more files have some data in common or where a given set of data occurs at multiple places within a given file. Duplication can also occur if the storage system backs up data by creating and maintaining multiple persistent point-in-time images, or “snapshots”, of stored data over a period of time. Data duplication generally is not desirable, since the storage of the same data in multiple places consumes extra storage space, which is a limited resource.

Consequently, in many large-scale storage systems, storage controllers have the ability to “deduplicate” data, which is the ability to identify and remove duplicate data blocks. In one known approach to deduplication, any extra (duplicate) copies of a given data block are deleted (or, more precisely, marked as free), and any references (e.g., pointers) to those duplicate blocks are modified to refer to the one remaining instance of that data block. A result of this process is that a given data block may end up being shared by two or more files (or other types of logical data containers).

In one known approach to deduplication, a hash algorithm is used to generate a hash value, or “fingerprint”, of each data block, and the fingerprints are subsequently used to detect possible duplicate data blocks. Data blocks that have the same fingerprint are likely to be duplicates of each other. When such possible duplicate blocks are detected, a byte-by-byte comparison can be done of those blocks to determine if they are in fact duplicates. By initially comparing only the fingerprints (which are much smaller than the actual data blocks), rather than doing byte-by-byte comparisons of all data blocks in their entirety, time is saved during duplicate detection.

One problem with this approach is that, if a fixed block size is used to generate the fingerprints, even a trivial addition, deletion or change to any part of a file can shift the remaining content in the file. This causes the fingerprints of many blocks in the file to change, even though most of the data has not changed. This situation can complicate duplicate detection.

To address this problem, the use of a variable block size hashing algorithm has been proposed. A variable block size hashing algorithm computes hash values for data between “anchor points”, which do not necessarily coincide with the actual block boundaries. Examples of such an algorithms are described in, for example, U.S. Patent Application Publication no. 2008/0013830 of Patterson et al., U.S. Pat. No. 5,990,810 of Williams, and International Patent Application publication no. WO 2007/127360 of Zhen et al. A variable block size hashing algorithm is advantageous, because it preserves the ability to detect duplicates when only a minor change is made to a file, since hash values are not computed based upon predefined data block boundaries.

Known file systems, however, generally are not well-suited for using a variable block size hashing algorithm because of their emphasis on having a fixed block size. Forcing variable block size in traditional file systems will tend to cause an increase in the amount of memory and disk space needed for metadata storage, thereby causing read performance penalties.

### SUMMARY

The technique introduced here includes a system and method for organizing stored data to facilitate data deduplication, particularly (though not necessarily) deduplication that is based on a variable block size hashing algorithm. In one embodiment, the method includes dividing a set of data, such as a file, into multiple subsets called “chunks”, where the chunk boundaries are independent of the block boundaries (due to the hashing algorithm). Metadata of the data set, such as block pointers for locating the data, are stored in a hierarchical metadata “tree” structure, which can be called a “buffer tree”. The buffer tree includes multiple levels, each of which includes at least one node. The lowest level of the buffer tree includes multiple nodes that each contain chunk metadata relating to the chunks of the data set. In each node of the lowest level of the buffer tree, the chunk metadata contained therein identifies at least one of the chunks. The chunks (i.e., the actual data, or “user-level data”, as opposed to metadata) are stored in one or more system files that are separate from the buffer tree and not visible to the user. This is in contrast with conventional file buffer trees, in which the actual data of a file is contained in the lowest level of the buffer tree. As such, the buffer tree of a particular file actually refers to one or more other files, that contain the actual data (“chunks”) of the particular file. In this regard, the technique introduced here adds an additional level of indirection to the metadata that is used to locate the actual data.

Segregating the user-level data in this way not only supports and facilitates variable block size deduplication, it also provides the ability for data to be placed at a heuristic based location or relocated to improve performance. This technique facilitates good sequential read performance and is relatively easy to implement since it uses standard file system properties (e.g., link count, size).

Other aspects of the technique introduced here will be apparent from the accompanying figures and from the detailed description which follows.

### BRIEF DESCRIPTION OF THE DRAWINGS

One or more embodiments of the present invention are illustrated by way of example and not limitation in the figures of the accompanying drawings, in which like references indicate similar elements and in which:

FIG. 1, which shows a network storage system in which the technique introduced here can be implemented;

FIG. 2 is a block diagram of the architecture of a storage operating system in a storage server;

FIG. 3 is a block diagram of a deduplication subsystem;

FIG. 4 shows an example of a buffer tree and the relationship between inodes, an inode file and the buffer tree;

FIGS. 5A and 5B illustrate an example of two buffer trees before and after deduplication of data blocks, respectively;

FIG. 6 illustrates an example of the contents of a direct (L0) block and its relationship to a chunk and a chunk file;

FIG. 7 illustrates a chunk shared by two files;

FIG. 8 is a flow diagram illustrating a process of processing and storing data in a manner which facilitates deduplication;

FIG. 9 is a flow diagram illustrating a process of efficiently reading data stored according to the technique in FIGS. 6 through 8; and

FIG. 10 is a high-level block diagram showing an example of the architecture of a storage system;

### DETAILED DESCRIPTION

References in this specification to “an embodiment”, “one embodiment”, or the like, mean that the particular feature, structure or characteristic being described is included in at least one embodiment of the technique being introduced. Occurrences of such phrases in this specification do not necessarily all refer to the same embodiment; however, the embodiments referred to are not necessarily mutually exclusive either.

The technique introduced here includes a system and method for organizing stored data to facilitate data deduplication, particularly (though not necessarily) deduplication based on a variable block size hashing algorithm. The technique be implemented (though not necessarily so) within a storage server in a network storage system. The technique can be particularly useful in a back-up environment where there is a relatively small number of backup files, which reference other small files (“chunk files”) for the actual data. Different algorithms can be used to generate the chunk files, so that successive backups result in a large number of duplicate files. Two backup files sharing all or part of a chunk file increment the link count of the chunk file to claim ownership of the chunk file. With this structure, a new backup then can directly refer to those files.

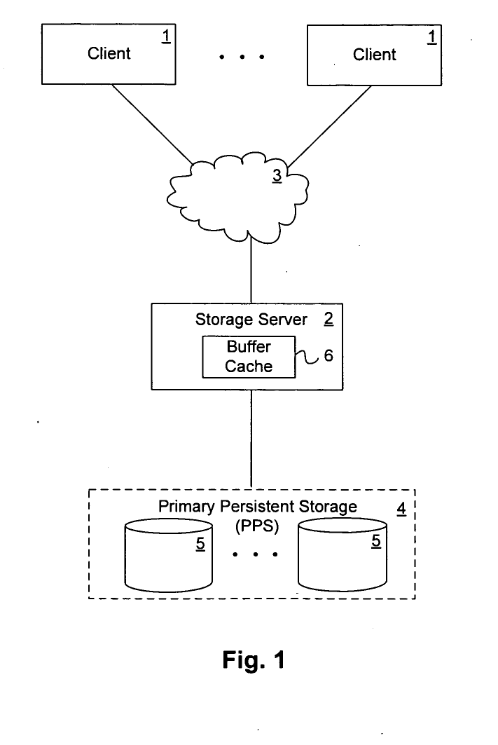

FIG. 1 shows a network storage system in which the technique can be implemented. Note, however, that the technique is not necessarily limited to storage servers or network storage systems. In FIG. 1, a storage server 2 is coupled to a primary persistent storage (PPS) subsystem 4 and is also coupled to a set of clients 1 through an interconnect 3. The interconnect 3 may be, for example, a local area network (LAN), wide area network (WAN), metropolitan area network (MAN), global area network such as the Internet, a Fibre Channel fabric, or any combination of such interconnects. Each of the clients 1 may be, for example, a conventional personal computer (PC), server-class computer, workstation, handheld computing/communication device, or the like.

Storage of data in the PPS subsystem 4 is managed by the storage server 2. The storage server 2 receives and responds to various read and write requests from the clients 1, directed to data stored in or to be stored in the storage subsystem 4. The PPS subsystem 4 includes a number of nonvolatile mass storage devices 5, which can be, for example, conventional magnetic or optical disks or tape drives; alternatively, they can be non-volatile solid-state memory, such as flash memory, or any combination of such devices. The mass storage devices 5 in PPS subsystem 4 can be organized as a Redundant Array of Inexpensive Disks (RAID), in which case the storage server 2 accesses the storage subsystem 4 using a RAID algorithm for redundancy.

The storage server 2 may provide file-level data access services to clients 1, such as commonly done in a NAS environment, or block-level data access services such as commonly done in a SAN environment, or it may be capable of providing both file-level and block-level data access services to clients 1. Further, although the storage server 2 is illustrated as a single unit in FIG. 1, it can have a distributed architecture. For example, the storage server 2 can be designed as a physically separate network module (e.g., “N-blade”) and disk module (e.g., “D-blade”) (not shown), which communicate with each other over a physical interconnect. Such an architecture allows convenient scaling, such as by deploying two or more N-modules and D-modules, all capable of communicating with each other through the interconnect.

The storage server 2 includes a storage operating system (not shown) to control its basic operations (e.g., reading and writing data in response to client requests). In certain embodiments, the storage operating system is implemented in the form of software and/or firmware stored in one or more storage devices in the storage server 1.

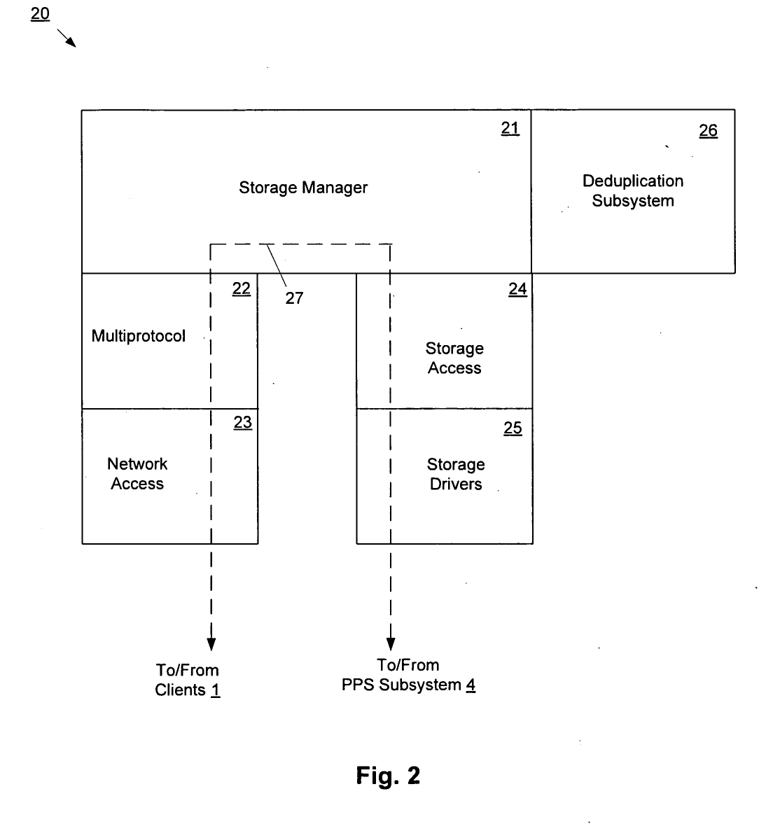

FIG. 2 schematically illustrates an example of the architecture of the storage operating system in the storage server 2. In certain embodiments the storage operating system 20 is implemented in the form of software and/or firmware. In illustrated embodiment, the storage operating system 20 includes several modules, or “layers”. These layers include a storage manager 21, which is the core functional element of the storage operating system 20. The storage manager 21 is application-layer software which imposes a structure (e.g., a hierarchy) on the data stored in the PPS subsystem 4 and which services read and write requests from clients 1. To improve performance, the storage manager 21 accumulates batches of writes in a buffer cache 6 (FIG. 1) of the storage server 6 and then streams them to the PPS subsystem 4 as large, sequential writes. In certain embodiments, the storage manager 21 implements a journaling file system and implements a “write out-of-place” (also called “write anywhere”) policy when writing data to the PPS subsystem 4. In other words, whenever a logical data block is modified, that logical data block, as modified, is written to a new physical storage location (physical block), rather than overwriting the data block in place.

To allow the storage server 2 to communicate over the network 3 (e.g., with clients 1), the storage operating system 20 also includes a multiprotocol layer 22 and a network access layer 23, logically “under” the storage manager 21. The multiprotocol 22 layer implements various higher-level network protocols, such as Network File System (NFS), Common Internet File System (CIFS), Hypertext Transfer Protocol (HTTP), Internet small computer system interface (iSCSI), and/or backup/mirroring protocols. The network access layer 23 includes one or more network drivers that implement one or more lower-level protocols to communicate over the network, such as Ethernet, Internet Protocol (IP), Transport Control Protocol/Internet Protocol (TCP/IP), Fibre Channel Protocol (FCP) and/or User Datagram Protocol/Internet Protocol (UDP/IP).

Also, to allow the storage server 2 to communicate with the persistent storage subsystem 4, the storage operating system 20 includes a storage access layer 24 and an associated storage driver layer 25 logically under the storage manager 21. The storage access layer 24 implements a higher-level disk storage protocol, such as RAID-4, RAID-5 or RAID-DP, while the storage driver layer 25 implements a lower-level storage device access protocol, such as Fibre Channel Protocol (FCP) or small computer system interface (SCSI).

Also shown in FIG. 2 is the path 27 of data flow through the storage operating system 20, associated with a read or write operation, from the client interface to the PPS interface. Thus, the storage manager 21 accesses the PPS subsystem 4 through the storage access layer 24 and the storage driver layer 25.

The storage operating system 20 also includes a deduplication subsystem 26 operatively coupled to the storage manager 21. The deduplication subsystem 26 is described further below.

The storage operating system 20 can have a distributed architecture. For example, the multiprotocol layer 22 and network access layer 23 can be contained in an N-module (e.g., N-blade) while the storage manager 21, storage access layer 24 and storage driver layer 25 are contained in a separate D-module (e.g., D-blade). The N-module and D-module communicate with each other (and, possibly, other N- and D-modules) through some form of physical interconnect.

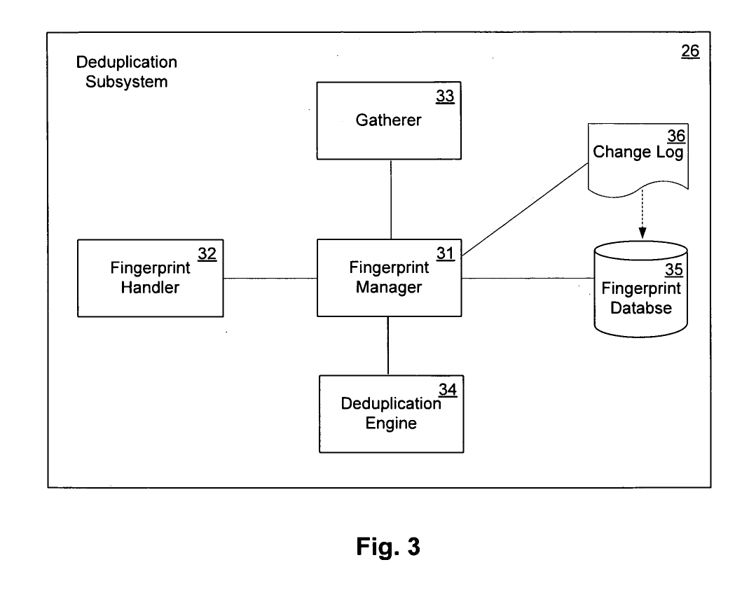

FIG. 3 illustrates the deduplication subsystem 26, according to one embodiment. As shown, the deduplication subsystem 26 includes a fingerprint manager 31, a fingerprint handler 32, a gatherer 33, a deduplication engine 34 and a fingerprint database 35. The fingerprint generator 32 uses a variable block size hashing algorithm to generate a fingerprint (hash value) of a specified set of data. Which particular variable block size hashing algorithm is used and the details of such algorithm are not germane to the technique introduced here. The result of executing of such algorithm is to divide a particular set of data, such as a file, into a set of chunks (as defined by anchor points), where the boundaries of the chunks do not necessarily coincide with the predefined block boundaries, and where each chunk is given a fingerprint.

The hashing function may be invoked when data is initially written or modified, in response to a signal from the storage manager 21. Alternatively, fingerprints can be generated for previously stored data in response to some other predefined event or at scheduled times or time intervals.

The gatherer 33 identifies new and changed data and sends such data to the fingerprint manager 31. The specific manner in which the gatherer identifies new and changed data is not germane to the technique being introduced here.

The fingerprint manager 31 invokes the fingerprint handler 32 to compute fingerprints of new and changed data and stores the generated fingerprints in a file 33, called the change log. Each entry in the change log 36 includes the fingerprint of a chunk and metadata for locating the chunk. The change log 36 may be stored in any convenient location or locations within or accessible to the storage controller 2, such as in the storage subsystem 4.

In one embodiment, when deduplication is performed the fingerprint manager 31 compares fingerprints within the change log 36 and compares fingerprints between the change log 36 and the fingerprint database 35, to detect possible duplicate chunks based on those fingerprints. The fingerprint database 35 may be stored in any convenient location or locations within or accessible to the storage controller 2, such as in the storage subsystem 4.

The fingerprint manager 31 identifies any such possible duplicate chunks to the deduplication engine 34, which then identifies any actual duplicates by performing byte-by-byte comparisons of the possible duplicate chunks, and coalesces (implements sharing of) chunks determined to be actual duplicates. After deduplication is complete, the fingerprint manager 35 copies to the fingerprint database 35 all fingerprint entries from the change log 36 that belong to chunks which survived the coalescing operation. The fingerprint manager 35 then deletes the change log 36.

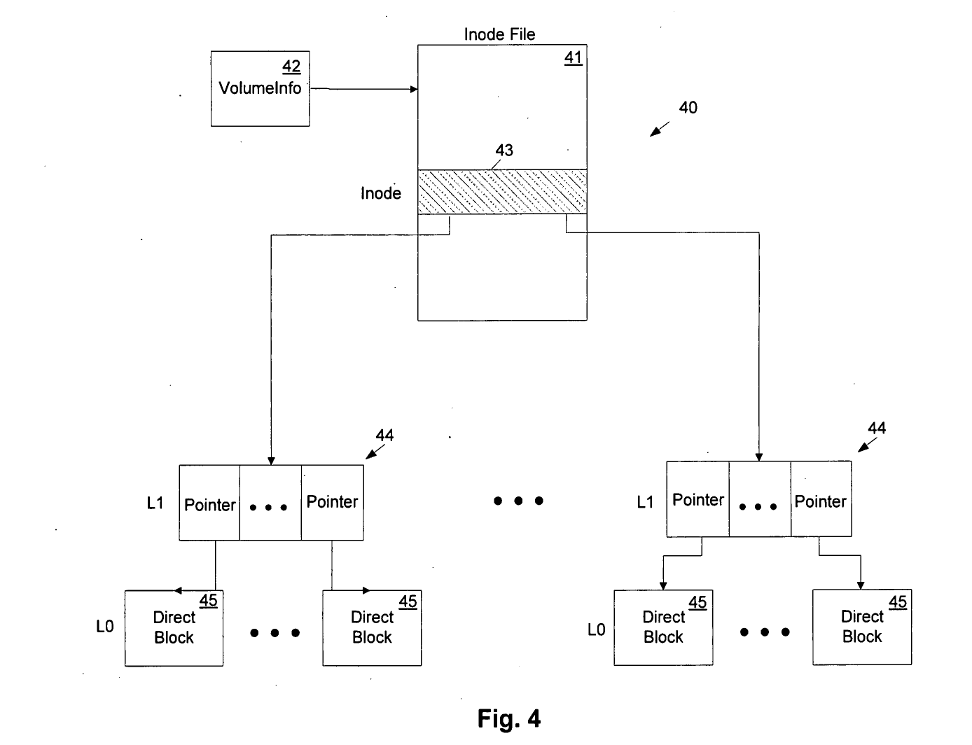

To better understand the technique introduced here, it is useful first to consider how data can be structured and organized by a storage server. Reference is now made to FIG. 4 in this regard. In at least one conventional storage server, data is stored in the form of files stored within directories (and, optionally, subdirectories) within or more volumes. A “volume” is a set of stored data associated with a collection of mass storage devices, such as disks, which obtains its storage from (i.e., is contained within) an aggregate (pool of physical storage), and which is managed as an independent administrative unit, such as a complete file system.

In certain embodiments, a file (or other form of logical data container, such as a logical unit or “LUN”) is represented in a storage server as a hierarchical structure called a “buffer tree”. In a conventional storage server, a buffer tree is a hierarchical structure which used to store both file data as well as metadata about a file, including pointers for use in locating the data blocks for the file. A buffer tree includes one or more levels of indirect blocks (called “level 1 (L1) blocks”, “level 2 (L2) blocks”, etc.), each of which contains one or more pointers to lower-level indirect blocks and/or to the direct blocks (called “level 0” or “L0 blocks”) of the file. All of the actual data in the file (i.e., the user-level data, as opposed to metadata) is stored only in the lowest level blocks, i.e., the direct (L0) blocks.

A buffer tree includes a number of nodes, or “blocks”. The root node of a buffer tree of a file is the “node” of the file. An inode is a metadata container that is used to store metadata about the file, such as ownership, access permissions, file size, file type, and pointers to the highest level of indirect blocks for the file. Each file has its own inode. Each inode is stored in an inode file, which is a system file that may itself be structured as a buffer tree.

FIG. 4 shows an example of a buffer tree 40 for a file. The file has an inode 43, which contains metadata about the file, including pointers to the L1 indirect blocks 44 of the file. Each indirect block 44 stores two or more pointers, each pointing to a lower-level block, e.g., a direct (L0) block 45. A direct block 45 in the conventional storage server contains the actual data of the file, i.e., the user-level data.

In contrast, in the technique introduced here, the direct (L0) blocks of a buffer tree store only metadata, such as chunk metadata. In the technique introduced here, the chunks are the actual data, which are stored in one or more system files which are separate from the buffer tree and hidden to the user.

For each volume managed by the storage server 2, the inodes of the files and directories in that volume are stored in a separate inode file, such as inode file 41 in FIG. 3 which stores inode 43. A separate inode file is maintained for each volume. The location of the inode file for each volume is stored in a Volume Information (“VolumeInfo”) block associated with that volume, such as VolumeInfo block 42 in FIG. 3. The VolumeInfo block 42 is a metadata container that contains metadata that applies to the volume as a whole. Examples of such metadata include, for example, the volume's name, type, size, any space guarantees to apply to the volume, and a pointer to the location of the inode file of the volume.

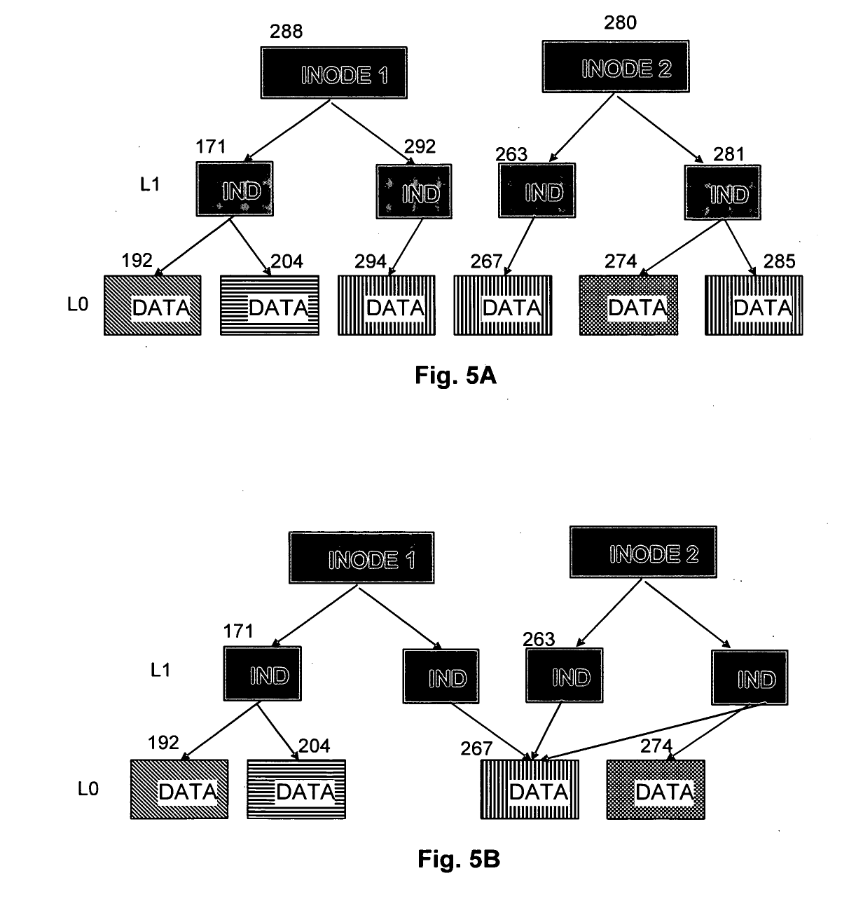

Now consider the process of deduplication with the traditional form of buffer tree (where the actual data is stored in the direct blocks). FIGS. 5A and 5B show an example of the buffer trees of two files, where FIG. 5A shows the two buffer trees before deduplication and FIG. 5B shows the two buffer trees after deduplication. The root blocks of the two files are Inode 1 and Inode 2, respectively. The three-digit numerals in FIGS. 5A and 5B are the values of the pointers to the various blocks and, in effect, therefore, are the identifiers of the data blocks. The fill patterns of the direct (LO) blocks in FIGS. 5A and 5B indicate the data content of those blocks, such that blocks shown with identical fill patterns are identical. It can be seen from FIG. 5A, therefore, that data blocks 294, 267 and 285 are identical.

The result of deduplication is that these three data blocks are, in effect, coalesced into a single data block, identified by pointer 267, which is now shared by the indirect blocks that previously pointed to data block 294 and data block 285. Further, it can be seen that data block 267 is now shared by both files. In a more complicated example, data blocks can be coalesced so as to be shared between volumes or other types of logical containers. Note that this coalescing operation involves modifying the indirect blocks that pointed to data blocks 294 and 285, and so forth, up to the root node. In a write out-of-place file system, that involves writing those modified blocks to new locations on disk.

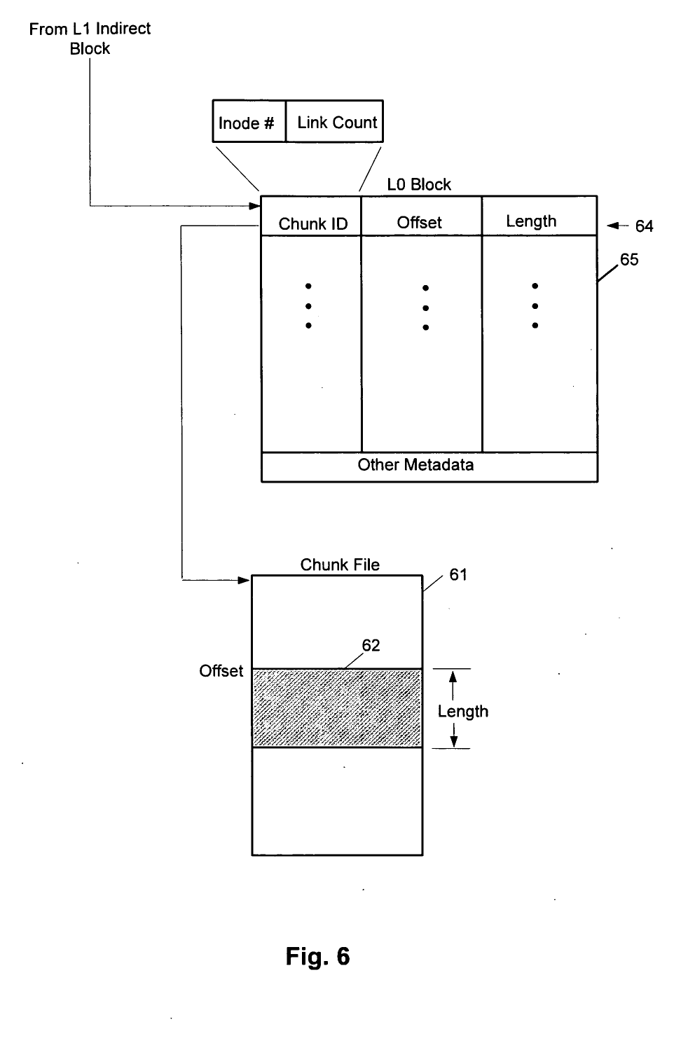

With the technique introduced here, deduplication can be implemented in a similar manner, although the actual data (i.e., user-level data) is not contained in the direct (L0) blocks, it is contained in chunks in one or more separate system files (chunk files). Segregating the user-level data in this way makes variable-sized block based sharing easy, while providing the ability for data to be placed at a heuristic based location or relocated (e.g., if a shared block is accessed more often from a particular file, File 1, the block can be stored closer to File 1's blocks). This approach is further illustrated in FIG. 6.

As shown in FIG. 6, the actual data for a file is stored as chunks 62 within one or more chunk files 61, which are system files that are hidden to the user. A chunk 62 is a contiguous segment of data that starts at an offset within a chunk file 61 and ends at an address determined by adding a length value relative to the offset. Each direct (LO) block 65 (i.e., each lowest level block) in the buffer tree (not shown) of a file contains one or more chunk metadata entries identifying the chunks in which the original user-level data for that direct block were stored. A direct block 65 can also contain other metadata, which is not germane to this description. A direct block 65 in accordance with the technique introduced here does not contain any of the actual data of the file. A direct block 65 can point to multiple chunks 62, which can be contained within essentially any number of separate chunk files 61.

Each chunk metadata entry 64 in a direct block 65 points to a different chunk and includes the following chunk metadata: a chunk identifier (ID), an offset value and a length value. The chunk ID includes the mode number of the chunk file 61 that contains the chunk 62, as well as a link count. The link count is an integer value which indicates the number of references that exist to that chunk file 61 within the volume that contains the chunk file 61. The link count is used to determine when a chunk can be safely deleted. That is, deletion of a chunk is prohibited as long as at least one reference to that chunk exists, i.e., as long as its link count is greater than zero. The offset value is the starting byte address where the chunk 62 starts within the chunk file 61, relative to the beginning of the chunk file 61. The length value is the length of the chunk 62 in bytes.

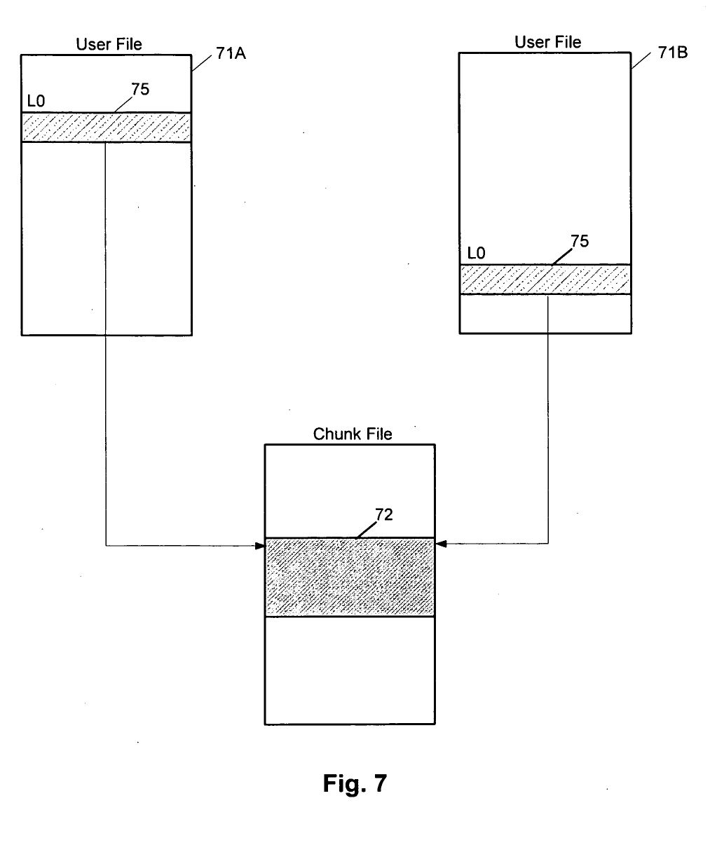

As shown in FIG. 7, two or more user-level files 71A, 71B can share the same chunk 72, simply by setting a chunk metadata entry within a direct (L0) block 75 of each file to point to that chunk.

In certain embodiments, a chunk file can contain multiple chunks. In other embodiments, each chunk is stored as a separate chunk file. The latter type of embodiment enables deduplication (sharing) of even partial chunks, since the offset and length values can be used to identify uniquely a segment of data within a chunk.

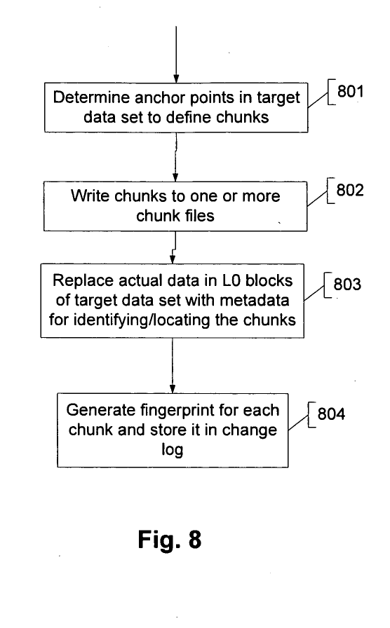

FIG. 8 illustrates a process that can be performed in a storage server 2 or other form of storage controller to facilitate deduplication in accordance with the technique introduced here. In one embodiment, the process is implemented by the storage manager layer 21 of the storage operating system 20. Initially, at 801 the process determines anchor points for a target data set, to define one or more chunks. The target data set can be, for example, a file, a portion of a file, or any other form of logical data container or portion thereof. This operation may be done in-line, i.e., in response to a write request and prior to storage of the data, or it can be done off-line, after the data has been stored.

Next, at 802 the process writes the identified chunks to one or more separate chunk files. The number of chunk files used is implementation-specific and depends on various factors, such as the maximum desired chunk size and chunk file size, etc. At 803, assuming an off-line implementation, the process replaces the actual data in the direct blocks in the buffer tree of the target data set, with chunk metadata for the chunks defined in 801. Alternatively, if the process is implemented in-line, then at 803 the direct blocks are originally allocated to contain the chunk metadata, rather than the actual data. Finally, at 804 the process generates a fingerprint for each chunk and stores the fingerprints in the change log 36 (FIG. 3).

An advantage of the technique introduced here is that deduplication can be effectively performed in-memory without any additional performance cost. Consider that in a traditional type of file system, data blocks are stored and accessed according to their inode numbers and file block numbers (FBNs). The inode number essentially identifies a file, and the FBN of a block indicates the logical position of the block within the file. A read request (such as in NFS) will normally refer to one or more blocks to be read by their inode numbers and FBNs. Consequently, if a block that is shared by two files is cached in the buffer cache according to one file's inode number, and is then requested by an application based on another file's inode number, the file system would have no way of knowing that the requested block was already cached (according to a different inode number and FBN). Consequently, the file system would initiate a read of that block from disk, even though the block is already in the buffer cache. This unnecessary read adversely affects the overall performance of the storage server.

In contrast, with the technique introduced here, data is stored as chunks, and every file which shares a chunk will refer to that chunk by using the same chunk metadata in its direct (L0) blocks, and chunks are stored and cached according to their chunk metadata. Consequently, once a chunk is cached in the buffer cache, if there is a subsequent request for an inode and FBN (block) that contains that chunk, the request will be serviced from the data stored in the buffer cache rather than causing another (unnecessary) disk read, regardless of the file that is the target of the read request.

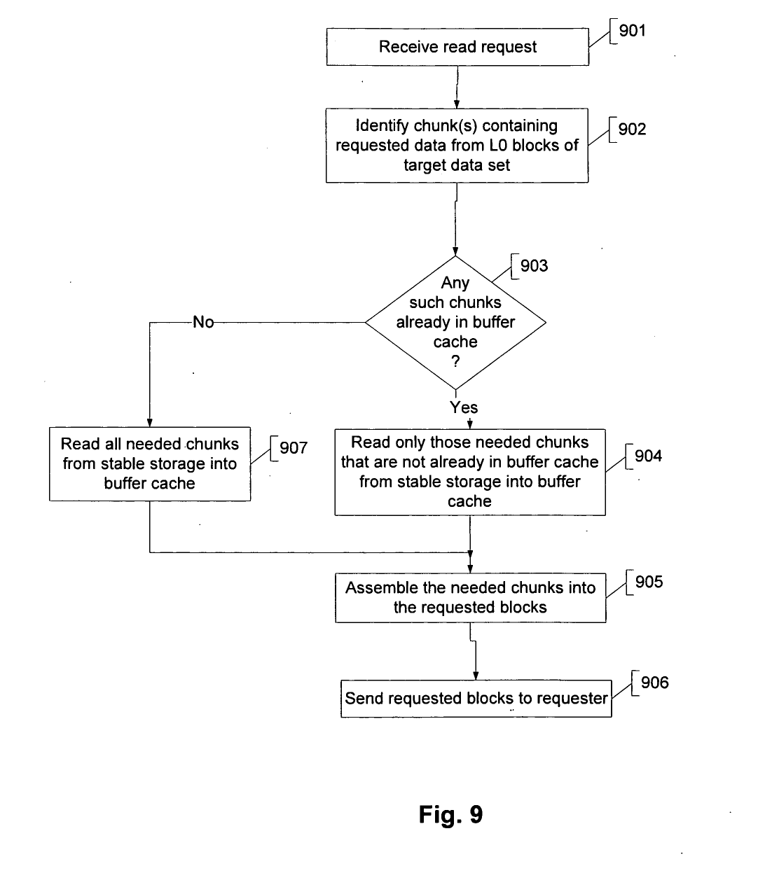

FIG. 9 shows a process by which the data and metadata structures described above can be used to service a read request efficiently. In one embodiment, the process is implemented by the storage manager 21 layer of the storage operating system 20. Initially, a read request is received at 901. At 902 the process identifies the chunk or chunks that contain the requested data, from the direct blocks targeted by the read requests. It is assumed that the read request contains sufficient information to locate the inode that is the root of the buffer tree of the target data set and then to “walk” down the levels of the buffer tree to locate the appropriate direct block(s) targeted by the request. If the original block data has been placed in more than one chunk, the direct block will point to each of those chunks. At 903, the process determines whether any of the identified chunks are already in the buffer cache (e.g., main memory, RAM). If none of the identified chunks are already in the buffer cache, the process branches to 907, where all of the identified chunks are read from stable storage (e.g., from PPS 4) into the buffer cache. On the other hand, if one or more of the needed chunks are already in the buffer cache, then at 904 the process reads only those chunks that are not already in the buffer cache, from stable storage into the buffer cache. The process then assembles the chunks into their previous form as blocks at 905 and sends the requested blocks to the requester at 906.

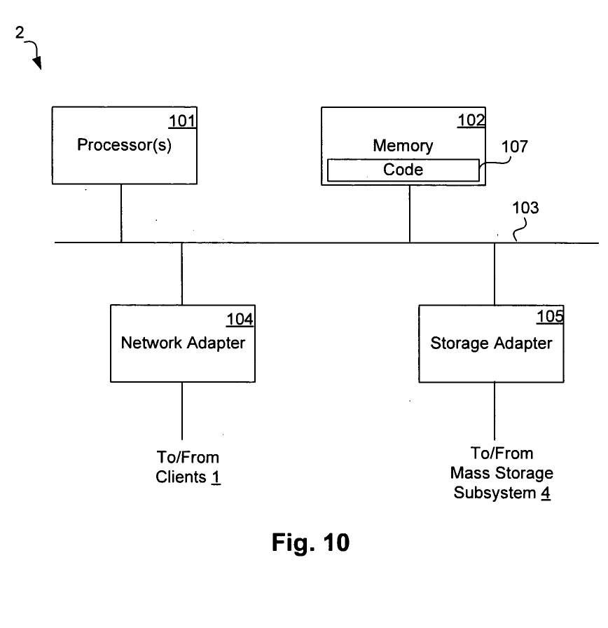

FIG. 10 is a high-level block diagram showing an example of the architecture of the storage server 2. The storage server 2 includes one or more processors 101 and memory 102 coupled to an interconnect 103. The interconnect 103 shown in FIG. 10 is an abstraction that represents any one or more separate physical buses, point-to-point connections, or both, connected by appropriate bridges, adapters, or controllers. The interconnect 103, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The processor(s) 101 is/are the central processing unit (CPU) of the storage server 2 and, thus, control the overall operation of the storage server 2. In certain embodiments, the processor(s) 101 accomplish this by executing software or firmware stored in memory 102. The processor(s) 101 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 102 is or includes the main memory of the storage server 2. The memory 102 represents any form of random access memory (RAM), read-only memory (ROM), flash memory, or the like, or a combination of such devices. In use, the memory 102 may contain, among other things, code 107 embodying the storage operating system 20.

Also connected to the processor(s) 101 through the interconnect 103 are a network adapter 104 and a storage adapter 105. The network adapter 104 provides the storage server 2 with the ability to communicate with remote devices, such as hosts 1, over the interconnect 3 and may be, for example, an Ethernet adapter or Fibre Channel adapter. The storage adapter 105 allows the storage server 2 to access the storage subsystem 4 and may be, for example, a Fibre Channel adapter or SCSI adapter.

The techniques introduced above can be implemented in software and/or firmware in conjunction with programmable circuitry, or entirely in special-purpose hardwired circuitry, or in a combination of such embodiments. Special-purpose hardwired circuitry may be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable storage medium and may be executed by one or more general-purpose or special-purpose programmable microprocessors. A “machine-readable storage medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

The term “logic”, as used herein, can include, for example, special-purpose hardwired circuitry, software and/or firmware in conjunction with programmable circuitry, or a combination thereof.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A method comprising:
dividing a set of data which is defined as a plurality of blocks into a plurality of chunks in a network storage system, wherein boundaries of the chunks are independent of boundaries of the blocks; and
storing metadata of the set of data, including pointers for locating the data, in a hierarchical structure in the network storage system, the hierarchical structure including a plurality of levels, each level including at least one node;
wherein a lowest level of the plurality of levels includes a plurality of nodes that each contain chunk metadata, and in each said node that contains chunk metadata, the chunk metadata identifies at least one of the chunks.

2. A method as recited in claim 1, wherein the nodes in the lowest level of the hierarchical structure do not contain any portion of the set of data.

3. A method as recited in claim 2, further comprising:
sharing a chunk, of the plurality of chunks, between a plurality of files, wherein each of the plurality of files is represented by a separate hierarchical structure, and wherein the hierarchical structure of each said file includes a lowest level node containing chunk metadata that identifies the shared chunk.

4. A method as recited in claim 1, further comprising:
writing the plurality of chunks into a plurality of chunk files.

5. A method as recited in claim 1, wherein each of the chunks is written into a separate chunk file, such that each chunk file includes only one chunk.

6. A method as recited in claim 1, wherein at least one of the chunk files includes two or more of the chunks.

7. A method as recited in claim 1, further comprising locating requested data in the set of data in response to a data access request, by:
using pointers in the hierarchical structure to locate a node in the lowest level of the hierarchical structure;
using chunk metadata in said node in the lowest level of the hierarchical structure to locate a chunk which contains the requested data; and
retrieving the requested data from a chunk file which contains the chunk which contains the requested data.

8. A method as recited in claim 7, wherein the chunk metadata in each of the nodes at the lowest level of the hierarchy includes:
chunk identifier metadata that identifies a chunk file;
an offset value that indicates an offset within the identified chunk file; and
a length value that indicates a length of data from the offset within the chunk file.

9. A method of storing data in a network storage system to facilitate data deduplication, the method comprising:
determining a plurality of anchor points for a set of data defined as a plurality of blocks in the network storage system, wherein the anchor points are independent of boundaries of the plurality of blocks;
dividing the set of data into a plurality of chunks according to the plurality of anchor points;
writing the plurality of chunks into a plurality of chunk files;
storing metadata including block pointers of the set of data in a hierarchical structure in the network storage system, the hierarchical structure including a plurality of levels, each said level including at least one node, wherein a lowest level of the plurality of levels includes a plurality of nodes that each store chunk metadata, wherein in each said node that contains chunk metadata the chunk metadata identifies at least one chunks in the plurality chunk files, wherein the nodes in the lowest level of the hierarchical structure do not contain any portion of the set of data; and
sharing a chunk, of the plurality of chunks, between two files to reduce duplication of data in said chunk, wherein each of the two files is represented by a hierarchical structure that includes a lowest-level node that includes chunk metadata identifying the shared chunk.

10. A method as recited in claim 9, wherein each of the nodes at the lowest level of the hierarchy contains chunk metadata that includes:
chunk identifier metadata that identifies a chunk file;
an offset value that indicates an offset within the identified chunk file; and
a length value that indicates a length of data from the offset within the chunk file.

11. A method comprising:
receiving at a network storage server a first request for data stored in a file system of the network storage server, wherein the data is part of a set of data defined in terms of a plurality of blocks, the first request specifying a file block number of the data and a root node identifier of a root node containing metadata of the data;
in response to the first request, retrieving the data from a stable storage of the network storage server into a buffer cache of the network storage server and sending the data to a requester;
receiving a second request for said data at the network storage server, the second request specifying a file block number of the data and a root node identifier of a root node containing metadata of the data, wherein the file block number and the root node identifier specified by the second request are different from, respectively, the file block number and the root node identifier specified by the first request; and
in response to the second request,
determining that the data is already in the buffer cache, and
providing the data from the buffer cache to a sender of the second request without having to reload the data into the buffer cache.

12. A method as recited in claim 11, wherein determining that the data is already in the buffer cache comprises:
identifying the data by using said file block number and said root node identifier to locate chunk metadata identifying a chunk, wherein boundaries of the chunk are not dependent upon block boundaries of any of the plurality of blocks; and
using the chunk metadata to identify the data.

13. A storage controller comprising:
a communication interface through which to communicate with a storage client over a network;
a storage interface through which to communicate with a stable storage facility;
a processor coupled to the communication interface and the storage interface; and
a storage medium containing code which, when executed by the processor, causes the storage controller to perform a process that includes
dividing a set of data into a plurality of chunks according to a plurality of anchor points, the data set including a plurality of blocks, wherein the anchor points are independent of boundaries of the blocks, and
storing metadata, including pointers for locating the data, in a hierarchical structure, the hierarchical structure including a plurality of levels, each level including at least one node, wherein a lowest level of the plurality of levels includes a plurality of nodes that each contain chunk metadata, wherein in each said node that contains chunk metadata, the chunk metadata identifies at least one of the chunks.

14. A storage controller as recited in claim 13, wherein the nodes in the lowest level of the hierarchical structure do not contain any portion of the set of data.

15. A storage controller as recited in claim 13, wherein said process further includes:
sharing a chunk, of the plurality of chunks, between a plurality of files, wherein each of the plurality of files is represented by a separate hierarchical structure, and wherein the hierarchical structure of each said file includes a lowest level node containing chunk metadata that identifies the shared chunk.

16. A storage controller as recited in claim 13, wherein said process further includes:
writing the plurality of chunks into a plurality of chunk files.

17. A storage controller as recited in claim 13, wherein each of the chunks is written into a separate chunk file, such that each chunk file includes only one chunk.

18. A storage controller as recited in claim 13, wherein at least one of the chunk files includes two or more of the chunks.

19. A storage controller as recited in claim 13, wherein said process further includes locating requested data in the set of data in response to a data access request, by:
using pointers in the hierarchical structure to locate a node in the lowest level of the hierarchical structure;
using chunk metadata in said node in the lowest level of the hierarchical structure to locate a chunk which contains the requested data; and
retrieving the requested data from a chunk file which contains the chunk which contains the requested data.

20. A storage controller as recited in claim 19, wherein the chunk metadata in each of the nodes at the lowest level of the hierarchy includes:
chunk identifier metadata that identifies a chunk file;
an offset value that indicates an offset within the identified chunk file; and
a length value that indicates a length of data from the offset within the chunk file.

21. A network storage system comprising:
means for communicating with a plurality of storage clients over a network;
means for determining a plurality of anchor points for a set of data defined as a plurality of blocks;
means for dividing the set of data into a plurality of chunks according to the plurality of anchor points, wherein boundaries of the chunks are independent of boundaries of the plurality of blocks;
means for writing the plurality of chunks into a plurality of chunk files;
means for storing metadata including block pointers of the set of data in a hierarchical structure in the network storage system, the hierarchical structure including a plurality of levels, each said level including at least one node, wherein a lowest level of the plurality of levels includes a plurality of nodes that each store chunk metadata, wherein in each said node that contains chunk metadata the chunk metadata identifies at least one chunk in the plurality chunk files; and
means for sharing a chunk, of the plurality of chunks, between two files to reduce duplication of data in said chunk, wherein each of the two files is represented by a hierarchical structure that includes a lowest-level node that includes chunk metadata identifying the shared chunk.

22. A network storage system as recited in claim 21, wherein each of the nodes at the lowest level of the hierarchy contains chunk metadata that includes:
chunk identifier metadata that identifies a chunk file;
an offset value that indicates an offset within the identified chunk file; and
a length value that indicates a length of data from the offset within the chunk file.

23. A machine-readable storage medium storing instructions which, when executed by a machine, cause the machine to perform a method of storing data in a network storage system to facilitate data deduplication, the method comprising:
determining a plurality of anchor points for a set of data defined as a plurality of blocks in the network storage system, wherein the anchor points are independent of boundaries of the plurality of blocks;
dividing the set of data into a plurality of chunks according to the plurality of anchor points;
writing the plurality of chunks into a plurality of chunk files;
storing metadata including block pointers of the set of data in a hierarchical structure in the network storage system, the hierarchical structure including a plurality of levels, each said level including at least one node, wherein a lowest level of the plurality of levels includes a plurality of nodes that each store chunk metadata, wherein in each said node that contains chunk metadata the chunk metadata identifies at least one chunk in the plurality chunk files; and
sharing a chunk, of the plurality of chunks, between two files to reduce duplication of data in said chunk, wherein each of the two files is represented by a hierarchical structure that includes a lowest-level node that includes chunk metadata identifying the shared chunk.

24. A machine-readable storage medium as recited in claim 23, wherein each of the nodes at the lowest level of the hierarchy contains chunk metadata that includes:
chunk identifier metadata that identifies a chunk file;
an offset value that indicates an offset within the identified chunk file; and
a length value that indicates a length of data from the offset within the chunk file.
